(19) United States
(12) Patent Application Publication
(10) Pub. No.: US 2025/0243969 A1
(43) Pub. Date: Jul. 31, 2025

(54) ELECTRICAL FIXTURE INSTALLATION DEVICE

(71) Applicant: Electrical Improvement Products LLC, Corning, NY (US)

(72) Inventor: Robert W. JACK, Corning, NY (US)

(73) Assignee: Electrical Improvement Products LLC, Corning, NY (US)

(21) Appl. No.: 18/424,953

(22) Filed: Jan. 29, 2024

(51) Int. Cl. F16M 13/02

(52) U.S. Cl. CPC F16M 13/02

(57) ABSTRACT

A fixture fitting device comprised of a multi-sided frame comprising first, second, third, and fourth side members; first, second, third, and fourth ears; and first and second mounting tabs. The device may be used to join an electrical fixture to an electrical box that is installed in a wall, such that the electrical fixture is in a desired position with respect to the wall in spite of the electrical box being installed recessed in the wall, and not coplanar with the wall surface.

### BACKGROUND

### Technical Field

Devices for optimizing installation of electrical fixtures in electrical boxes, and for providing desired positioning and stability of a fixture installed in a box.

### Description of Related Art

In modern residential, commercial, and industrial building construction, electrical wiring is installed within the walls of buildings. (Such “walls” as recited in this disclosure include vertical walls, and horizontal walls, i.e., floors and ceilings of rooms.) In like manner, communications wiring, such as telephone wiring, Ethernet (“Category 5”) cable, coaxial television (RG) cable is also installed in building walls. Moreover, fiber optic communication cables are also installed in building walls, and in some ways, have similarities to electrical wiring installation.

In order to make use of such wiring in a building, access to the wiring must be provided by installing electrical boxes in the walls, within which connections to the wiring can be made. Such boxes enclose the wiring connections and provide the functions of fire protection and electrical shock prevention to people in the building, as well as acting as mounting components for various electrical devices mounted to the boxes.

### SUMMARY

There remains a need for a device that can be used with common electrical boxes and fixtures, by which the position of an electrical fixture in an electrical box can be optimized with respect to the surface of a wall within which it is installed.

The device of the present disclosure meets this need by enabling an electrical fixture to be easily installed in an electrical box, regardless of the electrical box being recessed and not coplanar with the wall surface, as commonly occurs. In broad terms, the device is applicable in joining a first part to a second part. It is not required that the first part be an electrical fixture, and the second part be an electrical box in order for the device to perform its intended function.

More particularly, a fixture fitting device of the present disclosure is comprised of a multi-sided frame comprising a first, second, third, and fourth side members; first, second, third, and fourth ears; and first and second mounting tabs. The first side member includes a front edge and has a first end and a second end. The second side member is located opposite the first side member and includes a front edge and has a first end and a second end. The front edge of the first side member and the front edge of the second side member are coplanar and define a wall plane.

The third side member includes a front edge and has a first end joined to the first end of the first side member and a second end joined to the first end of the second side member. The fourth side member is located opposite the third side member and includes a front edge and has a first end joined to the second end of the first side member and a second end joined to the second end of the second side member. The front edge of the third side member and the front edge of the fourth side member are coplanar and define a front plane. The wall plane formed by the front edges of the first and second side members may be offset inwardly from the front plane for reasons that will be explained subsequently.

The first ear extends laterally from proximate to the first end of the third side member and includes a front surface and a rear surface. The second ear extends laterally from proximate to the second end of the third side member and includes a front surface and a rear surface. The third ear extends laterally from proximate to the first end of the fourth side member and includes a front surface and a rear surface. The fourth ear extends laterally from proximate to the second end of the fourth side member and includes a front surface and a rear surface.

The first mounting tab extends laterally from the first side member and includes a rearward surface, a forward surface, and a threaded hole extending through the first mounting tab from the forward surface of the first mounting tab to the rearward surface of the first mounting tab. The second mounting tab extends laterally from the second side member and includes a rearward surface, a forward surface, and a threaded hole extending through the second mounting tab from the forward surface of the second mounting tab to the rearward surface of the second mounting tab.

The front surface of the first ear, the front surface of the second ear, the front surface of the third ear, and the front surface of the fourth ear may be coplanar with the front plane. The rear surface of the first ear, the rear surface of the second ear, the rear surface of the third ear, and the rear surface of the fourth ear may be coplanar with the wall plane. The forward surface of the first mounting tab and the forward surface of the second mounting tab may be coplanar with the wall plane.

The first mounting tab and the second mounting tab may be metal tabs. The first mounting tab may be embedded in the first side member and the second mounting tab may be embedded in the second side member.

The fixture fitting device as described above may be used to join a first part to a second part. The first part is comprised of first and second mounting screws and first and second ears, each of the ears having a fastening hole therethrough. The second part is comprised of first and second tabs, each of the tabs having a threaded hole therethrough. In the assembly of the first part and the second part, the device disposed between the first part and the second part. The first mounting screw passes through the first fastening hole of the first part, though the threaded hole of the first mounting tab of the device, and through the threaded hole of the first tab of the first part, and the second mounting screw passes through the second fastening hole of the first part, though the threaded hole of the second mounting tab of the device, and through the threaded hole of the second tab of the second part. The device functions to hold the first part at a fixed distance from the second part. The first and second mounting screws hold the device at a fixed distance from the second part. In some cases, the first part may be an electrical fixture, and the second part may be an electrical box. In some cases, a surface of the first part is held contiguous with an edge of the device.

The device of the present disclosure as described above may be used to form an electrical fixture assembly that is joinable to an electrical box. The box may be comprised of a side wall terminating at an outer edge defining a planar opening, a first tab extending outwardly from a first side region of the side wall along the plane of the planar opening and including a first threaded hole therethrough, and a second tab extending outwardly from an opposed second side region of the side wall along the plane of the planar opening and including a second threaded hole therethrough.

The electrical fixture, such as an electrical receptacle, may be comprised of a planar plate, a first screw, and a second screw. The planar plate has a thickness and is comprised of a first end region including a first ear with a first hole therethrough, and an opposed second end region including a second ear with a second hole therethrough. The first screw is comprised of a first head and a first elongated threaded shank. The first head of the first screw is disposed against the first ear of the planar plate of the electrical fixture, and the first threaded shank extends through the first hole of the first ear, and is engageable with threads in the first threaded hole of the first tab of the box. The second screw is comprised of a second head and a second elongated threaded shank. The second head of the second screw is disposed against the second ear of the planar plate of the electrical fixture, and the second threaded shank extends through the second hole of the second ear, and is engageable with threads in the second threaded hole of the second tab of the box.

When the assembly is joined to the box, the first screw passes through the first hole of the electrical fixture, though the threaded hole of the first mounting tab of the fixture joining device, and through the threaded hole of the first tab of the box, and the second mounting screw passes through the second hole of the electrical fixture, though the threaded hole of the second mounting tab, and through the threaded hole of the second tab of the box. In the final installed position of the electrical fixture in the box, the device holds the electrical fixture at a fixed distance from the box. During part of the joining the electrical fixture to the box, and in the final installed position of the electrical fixture in the box, the first and second mounting screws hold the device at a fixed distance from the box.

As noted above, the front edge of the first side member and the front edge of the second side member of the device may be coplanar and define a wall plane, and the front edge of the third side member and the front edge of the fourth side member may be coplanar and define a front plane. In such cases, the wall plane may be offset inwardly from the front plane. The amount offset of the front plane from the wall plane may be equal to the thickness of the planar plate of the electrical fixture.

Each of the foregoing implementations, devices and methods may be employed individually or in conjunction.

### BRIEF DESCRIPTION OF THE DRAWINGS

The present disclosure will be provided with reference to the following drawings, in which like numerals refer to like elements, and in which:

FIGS. 1A and 1B are perspective and side elevation views of a conventional electrical receptacle mounted in a desired position, with the front opening of a box that holds a support plate of the receptacle coplanar with the surface of the wall in which the box is mounted;

FIG. 2A is a front elevation view of the fixture fitting device of the present disclosure;

FIG. 2B is a rear elevation view of the fixture fitting device of the present disclosure;

FIG. 2C is a side elevation view of the fixture fitting device of the present disclosure, taken along line 2C-2C of FIG. 2A;

FIG. 2D is a front upper perspective view of the fixture fitting device of the present disclosure;

FIG. 2E is a top view of the fixture fitting device of the present disclosure, taken along line 2E-2E of FIG. 2A;

FIG. 2F is a front upper perspective view of a mounting tab of the fixture fitting device of the present disclosure;

FIG. 3 is a fully exploded perspective view of a cover plate, receptacle mounting screws, electrical receptacle, and fixture fitting device of the present disclosure, and a box that holds the receptacle mounted to a wall, with a front opening of the box located beneath the surface of the wall;

FIG. 4 is an exploded side elevation view of the components and wall depicted in FIG. 3, but with the receptacle mounting screws engaged with the electrical receptacle;

FIG. 5A is a side elevation view of the components and wall, but with the mounting screws of the electrical receptacle making initial contact with the mounting tabs of the fixture fitting device;

FIG. 5B is a perspective view of the components and wall as depicted in FIG. 5A;

FIG. 5C is a detailed perspective view of the components and wall as depicted in FIG. 5B, showing the top region of the partially assembled components in greater detail;

FIG. 6A is a side elevation view of the components and wall, but with the mounting screws of the electrical receptacle threaded through the mounting tabs of the fixture fitting device and making initial contact with the threaded tabs of the electrical box, and with ears of the fixture fitting device being contiguous with the outer surface of the wall;

FIG. 6B is a perspective view of the components and wall as depicted in FIG. 6A;

FIG. 6C is a detailed perspective view of the components and wall as depicted in FIG. 6B, showing the top region of the partially assembled components in greater detail;

FIG. 7A is a side elevation view of the components and wall, but with the electrical receptacle mounted in its final position in the box, with the mounting plate of the receptacle held coplanar with the surface of the wall by the fixture fitting device;

FIG. 7B is a perspective view of the components and wall as depicted in FIG. 7A; and

FIG. 7C is a detailed perspective view of the components and wall as depicted in FIG. 7B, showing the top portion of the receptacle, the top mounting screw, and the fixture fitting device in their final positions in greater detail.

The present invention will be described in connection with certain preferred embodiments. However, it is to be understood that there is no intent to limit the invention to the embodiments described. On the contrary, the intent is to cover all alternatives, modifications, and equivalents as may be included within the spirit and scope of the invention as defined by the appended claims.

### DETAILED DESCRIPTION

For a general understanding of the present invention, reference is made to the drawings. In the drawings, like reference numerals have been used throughout to designate identical elements. The drawings are to be considered exemplary, and are for purposes of illustration only. The dimensions, positions, order and relative sizes reflected in the drawings attached hereto may vary.

In the following disclosure, the present invention is described in the context of its use as embodied in a wall-mounted electrical receptacle that is provided with the capability to adjust the position of mounting in a desired position in a wall regardless of errors in mounting an electrical box to which it is joined. However, it is not to be construed as being limited only to use in electrical receptacles. The invention is adaptable to any use in which adjustment capability is desirable to be provided for a wall-mounted object, so as to render a reference plane of the object coplanar with a surface of the wall. Additionally, the description identifies certain components with the adjectives “top,” “upper,” “bottom,” “lower,” “left,” “right,” etc. These adjectives are provided in the context of use of the invention embodied in an electrical receptacle, and in the context of the orientation of the drawings, which is arbitrary. The description is not to be construed as limiting the present invention to use in a particular spatial orientation. The present invention may be used in orientations other than those shown and described herein.

It is also to be understood that any connection references used herein (e.g., attached, coupled, connected, and joined) are to be construed broadly and may include intermediate members between a collection of elements and relative movement between elements unless otherwise indicated. As such, connection references do not necessarily imply that two elements are directly connected and in fixed relation to each other unless otherwise indicated.

The terms “about” and “substantially” are used herein with respect to measurable values and ranges due to expected variations known to those skilled in the art (e.g., limitations and variabilities in measurements).

Additionally, it is to be understood that as used herein, reference to a building “wall” is meant to include not only vertical walls, but also horizontal walls, such as floors and ceilings, and angled walls, such as interior surfaces of roofs.

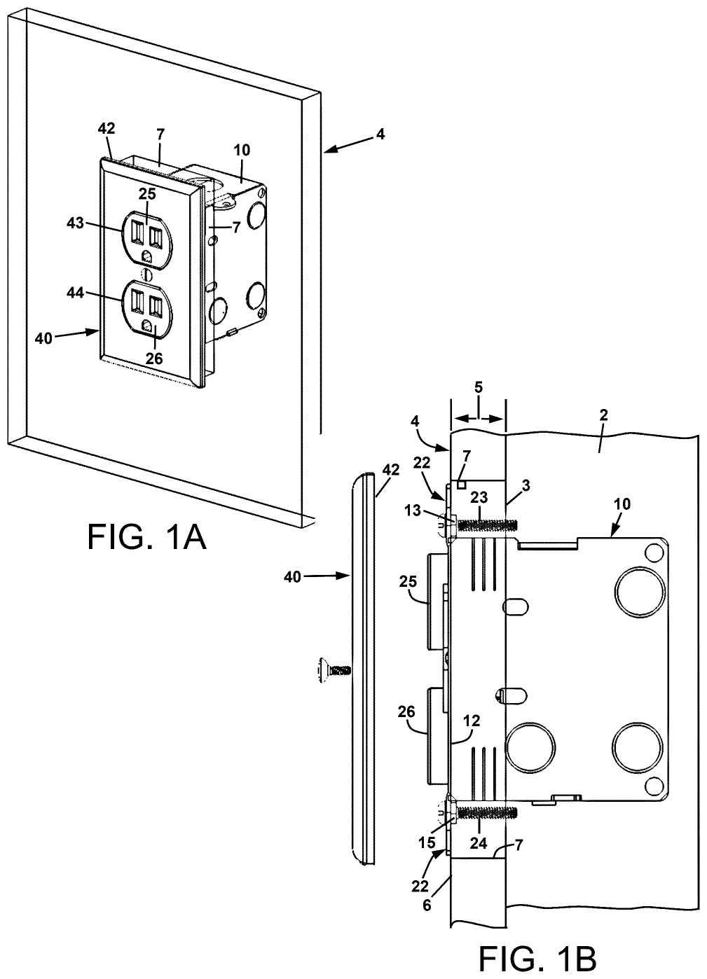

For the sake of clarity in defining the need and use of the device of the present disclosure, FIGS. 1A and 1B are provided and described first. FIGS. 1A and 1B depict a conventional electrical receptacle mounted in a desired position, with the front opening of a box that holds the receptacle being coplanar with the surface of the wall in which the box is mounted. This desired position is obtained when the electrician joins the box 10 to the stud 2 such that the front opening 12 of the box 10 protrudes beyond the front surface 3 of the stud by an amount equal to the thickness 5 of the wall panel 4 (such as drywall) to be joined to the stud 2. Thus when a cutout 7 is made at the proper location in the wall panel 4, and the wall panel 4 is joined to the stud 2 (or other wall framing), the box 10 protrudes through the cutout 7 in the wall panel 4 such that the front opening 12 of the box 10 is coplanar with the outer surface 6 of the wall panel 4.

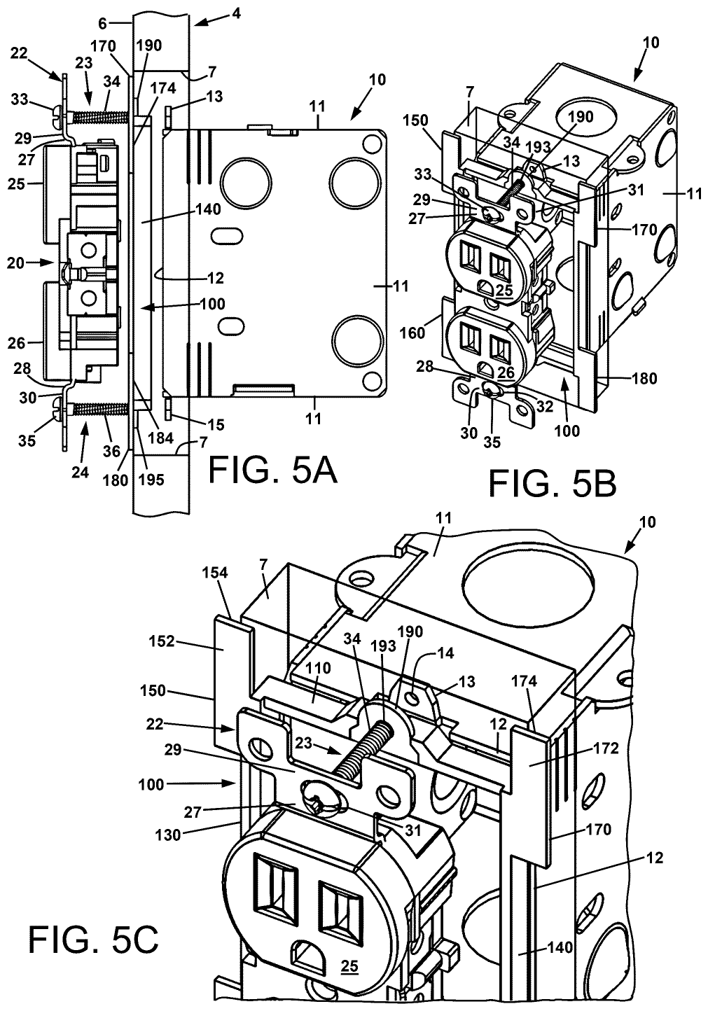

The benefits of this arrangement are readily apparent. The receptacle 20 is comprised of a planar plate 22 of material, such as metal plate. (See also FIGS. 4, 5A, and 5C.) When the receptacle 20 is joined to the box 10 by upper and lower screws 23 and 24 engaged with threaded holes 14 and 16, which are provided in upper and lower tabs 13 and 15, the back side planar plate 22 of the receptacle is also coplanar with the front opening 12 of the box 10. This relationship enables the joining of the cover plate 40 to the receptacle as shown in FIG. 1A, with the outer back edge 42 of the cover plate 40 being contiguous with the outer surface 6 of the wall panel 4. Additionally, the plug holes 43 and 44 of the cover plate 40 are in close proximity to the plug bodies 25 and 26 of the receptacle 20. This close fit is highly desirable for both safety (fire and shock prevention) and aesthetic reasons.

Certain problems may arise when installing an electrical fixture in an electrical box, and in particular, when the electrical box is not properly located relative to the external surface of the wall within which it is installed. Some of such problems are described and shown in detail in commonly owned U.S. Pat. No. 9,859,696, the disclosure of which is incorporated herein by reference.

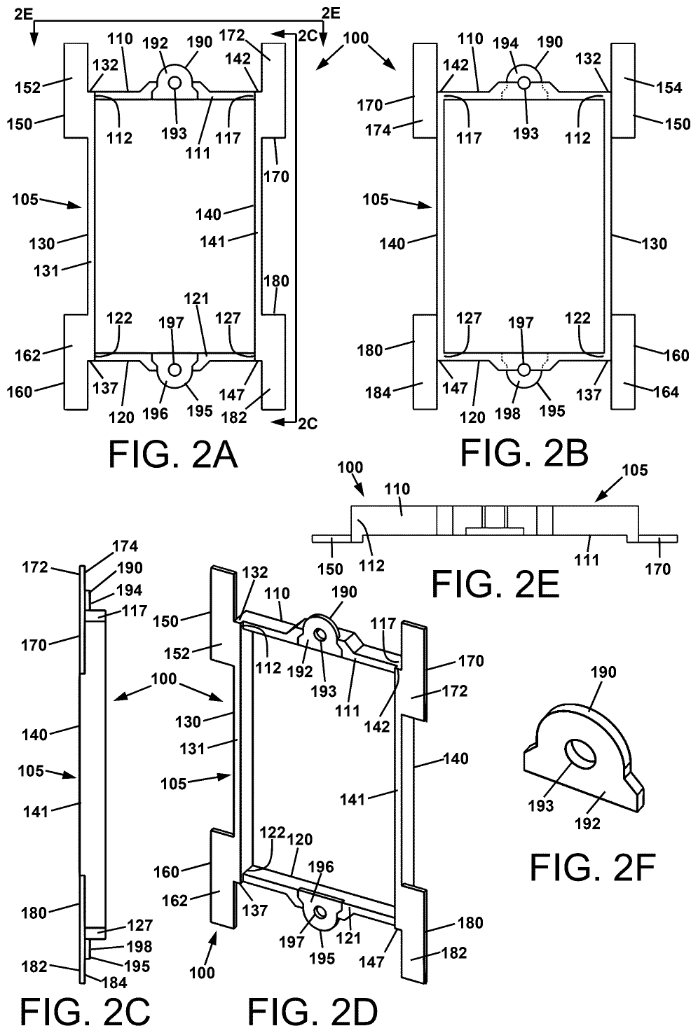

The fixture fitting device of the present disclosure solves such problems, as will now be described in detail. FIGS. 2A-2E depict front elevation, rear elevation, side elevation, and front upper perspective, and top views, respectively, of the device 100.

Referring to FIGS. 2A-2E, the fixture fitting device 100 is comprised of a multi-sided frame 105 comprising first, second, third, and fourth side members, first, second, third, and fourth ears, and first and second mounting tabs. The first side member 110 includes a front edge 111 and has a first end 112 and a second end 117. The second side member 120 is located opposite the first side member 110 and includes a front edge 121 and has a first end 122 and a second end 127. The front edge 111 of the first side member 110 and the front edge 121 of the second side member 120 are coplanar and define a wall plane.

The third side member 130 includes a front edge 131 and has a first end 132 joined to the first end 112 of the first side member 110 and a second end 137 joined to the first end 122 of the second side member 120. The fourth side member 140 is located opposite the third side member 130 and includes a front edge 141 and has a first end 142 joined to the second end 117 of the first side member 110 and a second end 147 joined to the second end 127 of the second side member 120. The front edge 131 of the third side member 130 and the front edge 141 of the fourth side member 140 are coplanar and define a front plane. The wall plane formed by the front edges 111 and 121 of the first and second side members 110 and 120 is offset inwardly from the front plane for reasons that will be explained subsequently.

The first ear 150 extends laterally from proximate to the first end 132 of the third side member 130 and includes a front surface 152 and a rear surface 154. The second ear 160 extends laterally from proximate to the second end 137 of the third side member 130 and includes a front surface 162 and a rear surface 164. The third ear 170 extends laterally from proximate to the first end 142 of the fourth side member 140 and includes a front surface 172 and a rear surface 174. The fourth ear 180 extends laterally from proximate to the second end 147 of the fourth side member 140 and includes a front surface 182 and a rear surface 184.

The first mounting tab 190 extends laterally from the first side member 110 and includes a rearward surface 194, a forward surface 192, and a threaded hole 193 extending through the first mounting tab 190 from the forward surface 192 of the first mounting tab 190 to the rearward surface 194 of the first mounting tab 190. The second mounting tab 195 extends laterally from the second side member 120 and includes a rearward surface 198, a forward surface 196, and a threaded hole 197 extending through the second mounting tab 195 from the forward surface 196 of the second mounting tab 195 to the rearward surface 198 of the second mounting tab 195.

The front surface 152 of the first ear 150, the front surface 162 of the second ear 160, the front surface 172 of the third ear 170, and the front surface 182 of the fourth ear 182 may be coplanar with the front plane defined by the front edges 111 and 121 of the first and second side members 110 and 120. The rear surface 154 of the first ear 150, the rear surface 164 of the second ear 160, the rear surface 174 of the third ear 170, and the rear surface 184 of the fourth ear 180 may be coplanar and may define a rear plane. When an electrical receptacle is mounted in an electrical box as will be described subsequently, the rearward surfaces are contiguous with the surface of the wall in which the receptacle is installed, thereby providing support to the receptacle and maintaining it in the desired mounted position.

The forward surface 192 of the first mounting tab 190 and the forward surface 196 of the second mounting tab 195 may be coplanar with the wall plane. The first mounting tab 190 and the second mounting tab 195 may be formed integrally with the first side member 110 and the second side member 120, respectively. In other cases, the first mounting tab 190 and the second mounting tab 195 may be formed separately and joined to the first side member 110 and the second side member 120, respectively. FIG. 2F is a front upper perspective view of such a separate mounting tab 190; mounting tab 195 may be identical to mounting tab 190 and is thus not presented separately in the drawings. In some cases, the first mounting tab 190 and the second mounting tab 195 may be joined to the first side member 110 and the second side member 120 by adhesive. In other cases, the first mounting tab 190 may be embedded in the first side member 110 and the second mounting tab 195 may be embedded in the second side member 120.

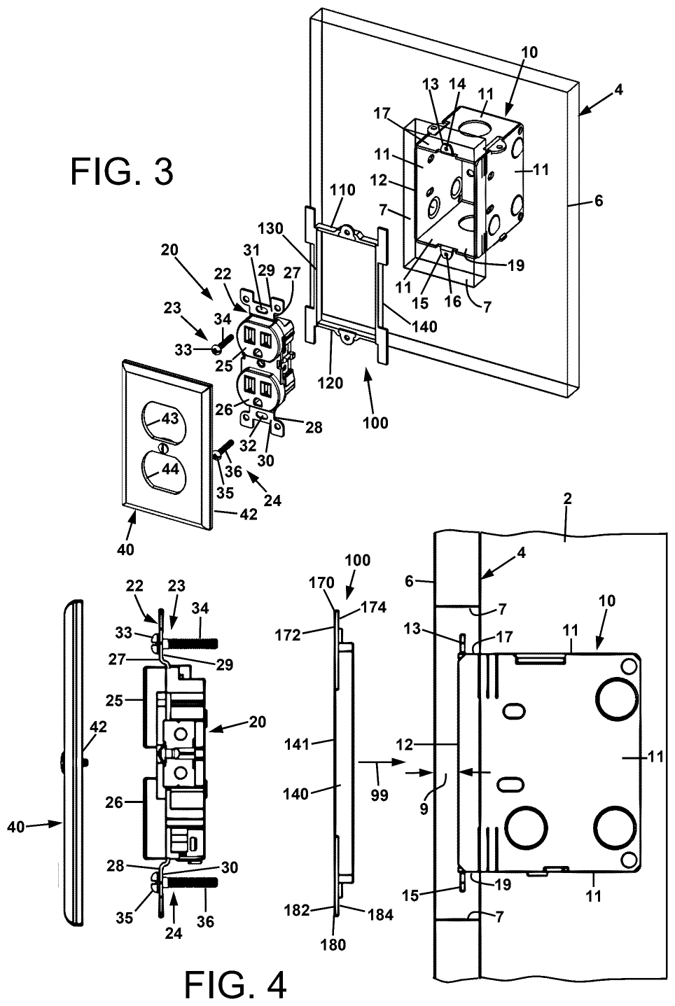

The fixture fitting device and electrical fixtures of the present disclosure will now be described with reference to the detailed drawings of the device 100 shown in FIGS. 2A-2F and to FIGS. 3-7C. These drawings illustrate one exemplary embodiment of an electrical fixture, the exemplary embodiment being an electrical receptacle for providing 120 volts AC to electrical devices (not shown) connected thereto. It is to be understood that the application is to be considered exemplary, and that the fixture fitting device is usable with other electrical fixtures, including but not limited to lighting fixtures, ceiling fans, alarms, doorbells, smoke detectors, thermostats, telephone jacks, cable TV jacks, and Ethernet cable jacks. The fixture fitting device is also usable with other fixtures that are non-electrical fixtures.

FIGS. 3-7C depict a sequence of steps for joining an exemplary electrical receptacle to an electrical box using the fixture fitting device 100 of the present disclosure. Thus FIGS. 3-7C depict not only the device, fasteners, and electrical fixture (e.g., a receptacle), but also a method for joining a fixture to a box.

Referring first to FIG. 3, a fully exploded perspective view of a cover plate, receptacle mounting screws, electrical receptacle, and device of the present disclosure are depicted, along with a box that holds the receptacle. It is noted that for clarity of illustration, in FIGS. 3-7C, the wall panel that is depicted therein is shown as if it were transparent so that that the various components or portions thereof that would otherwise be hidden by the wall, as well as their relationships to the wall, can be “seen” and understood. Additionally, the although the cutout in the wall panel is depicted as being a simple rectangle, in an actual electrical box and receptacle installation by an electrician in a wall panel, such cutouts may have somewhat irregular shapes due to the cutting of the wall panel by a hand tool. It is also noted that in the situation depicted in FIGS. 3-7C, the electrical box is “improperly mounted” to the framing stud 2. Thus a problem caused by the front opening 12 of the box 10 being recessed beneath the plane defined by the outer surface 6 of the wall 4, such gap 9 being shown in particular in FIG. 4, is present. This problem is solved by the device of the present disclosure, as will now be described.

Referring again to FIG. 3, an electrical receptacle 20, i.e., a “first part” referred to in this disclosure, is shown ready to be mounted in an electrical box 10, i.e., a “second part” referred to in this disclosure, using the device 100 of the present disclosure. The electrical box 10 is comprised of a side wall 11 terminating at an outer edge 12. The outer edge 12 of box 10 defines a planar opening, which as described above, is recessed relative to the plane of the surface 6 of wall panel 4, due to the manner in which box 10 is joined to the wall stud. (The stud is not shown in FIGS. 3 and 5A-6C, but may be as depicted for stud 2 of FIGS. 1B and 4). It is noted that the side wall 11 of the box 10 of FIGS. 5-7C has a rectangular shape, which is formed to receive the approximately rectangular form of the receptacle 20. However, it is to be understood that boxes having other shapes made to correspond to the electrical fixtures being mounted to them may be used. For example, the electrical boxes may have square, octagonal, or circular shapes, as are commonly used in electrical wiring applications.

The box 10 includes a first tab 13 extending outwardly from a first side region 17 of the side wall 11 along the plane of the planar outer edge 12. The first tab 13 has a threaded hole 14 for engaging with a screw 23 of the receptacle 10. In like manner, the box 10 includes a second tab 15 extending outwardly from a second side region 19 of the side wall 11 along the plane of the planar outer edge 12. The second tab 15 has a threaded hole 16 for engaging with a screw 24 of the receptacle 10.

The electrical fixture 20 is comprised of a planar plate 22. In the case depicted in FIGS. 3-7C, in which the electrical fixture 20 is an electrical receptacle, the electrical receptacle 20 may include plug bodies 25 and 26 that are joined to the planar plate 22.

The planar plate 22 is comprised of a first end region 27 including a first ear 29 with a first hole 31 therethrough, and an opposed second end region 28 including a second ear 30 with a second hole 32 therethrough. In the installation of the electrical receptacle 20 in the box 10, and in the event that the box 10 is skewed on the stud 2, the holes 31 and 32 provide some adjustability of the vertical alignment of the planar plate, so that the plug bodies 25 and 26 are aligned vertically, and their faces are parallel to the plane of the wall board 7, thus providing a pleasing aesthetic appearance when the cover plate 40 is joined to the receptacle 20.

Referring again to FIG. 3, and also to FIG. 4, the first screw 23 is comprised of a first head 33 and a first elongated threaded shank 34. The first head 33 of the first screw 23 is disposable against the first ear 29 of the planar plate 22 of the electrical receptacle 20, with the first threaded shank 34 extending through the first hole 31 of the first ear 29 and engaged with and extending through the threaded hole 193 of the first mounting tab 190 of the device 100, and engageable with threads in the threaded hole 14 of the first tab 13 of the box 10. In like manner, the second screw 24 is comprised of a second head 35 and a second elongated threaded shank 36. The second head 35 of the second screw 24 is disposable against the second ear 30 of the planar plate 22, with the second threaded shank 36 extending through the second hole 32 of the second ear 30 and engaged with and extending through the threaded hole 197 of the second mounting tab 195 of the device 100, and engageable with threads in the threaded hole 16 of the second tab 15 of the box 10.

Typically, an electrical receptacle 20 is sold with the first and second screws 23 and 24 included as depicted in FIG. 4. Tinnerman-type retainer plates (not shown) made of a suitable thin plastic or fiber board material may be threaded onto the shanks 34 and 36 of the screws 23 and 24 to function as retainers so that the screws 23 and 24 do not get lost before installation of the receptacle 20 on the box 10. If these are present on a receptacle, they may be removed before proceeding with the joining of a receptacle 20 to a box 10 as described herein.

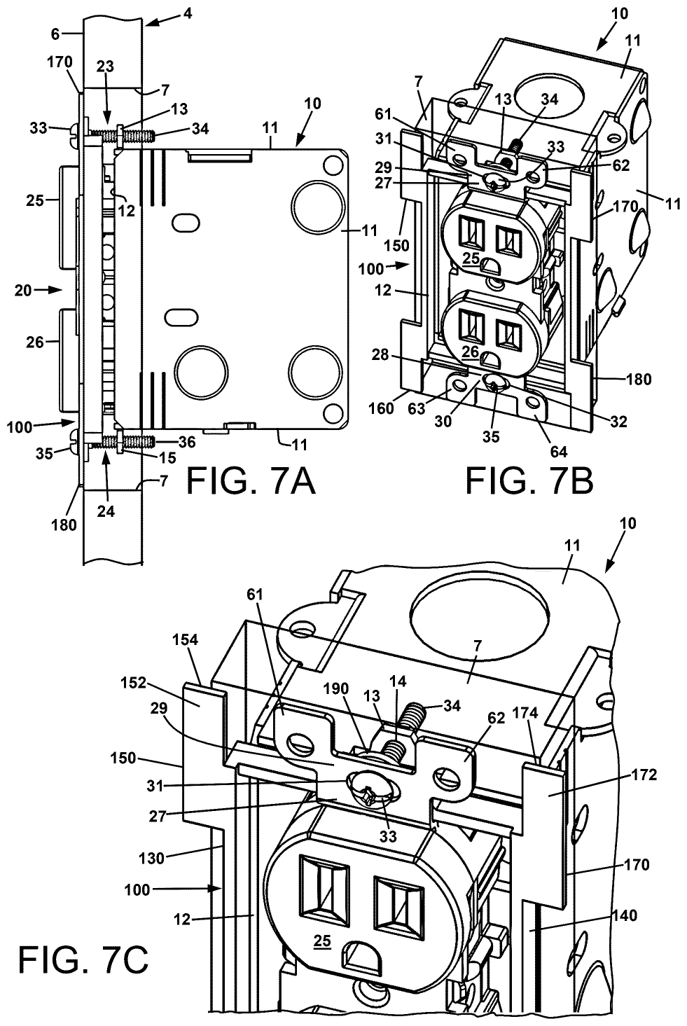

FIGS. 5A-7C in particular depict the sequence of steps executed by an electrician for joining the electrical receptacle 10 to the electrical box 20, using the device 100 to position the receptacle 20 in its final installed position as depicted in FIGS. 7A-7C, with the outer surface of the planar plate 22 of the receptacle 20 being coplanar with the surface 6 of the wall panel 4. Thus when the cover plate 40 is joined to the electrical receptacle 20, a pleasing aesthetic appearance and a safe installation is achieved, in spite of the problematic mismatch of the plane of the front edge 12 of the box 10 and the wall surface 6.

Referring first to FIG. 4 and FIGS. 5A-5C, as a first step, the electrician moves the device 100 toward the wall panel 4 and electrical box 20 as indicated by arrow 99, until the rear surfaces 154, 164, 174, and 184 of the respective ears 150, 160, 170, and 180 are contiguous with the surface 6 of the wall panel 4. The electrician then moves the receptacle 20 with assembled screws 23 and 24 to the position relative to the device 100 as shown in FIG. 5A-5C, with the respective screws 23 and 24 positioned to engage with the respective threaded holes 193 and 197 of mounting tabs 190 and 195. It is noted that at this point of the installation, electrical wires contained within box 10 would be connected to various terminals on the receptacle 20. However, depiction of such wires is not required for understanding the present disclosure, and so for simplicity of illustration, such wires are not shown.

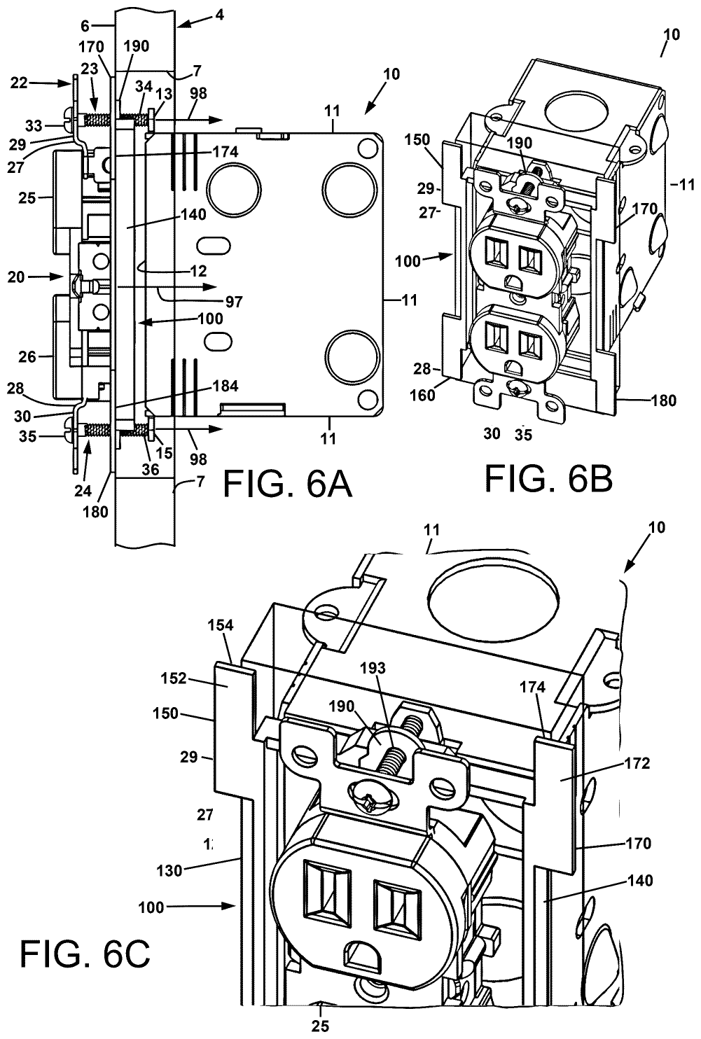

The electrician then turns the screws 23 and 24, engaging them with and driving them through the respective threaded holes 193 and 197 of mounting tabs 190 and 195 of the device 100. The electrician turns the screw 23 until it contacts the threaded hole 14 of tab 13 of the electrical box 10 as shown in FIGS. 6A-6C. In like manner, the electrician turns the screw 24 until it contacts the threaded hole 16 of tab 15 of the electrical box 10, also as shown in FIGS. 6A-6C.

The electrician further turns the screws 23 and 24 thereby advancing the screws 23 and 24 into the respective threaded holes 14 and 16 of the box 10, and further inward horizontally relative to the box 10 as indicated by arrows 98. Once the screws 23 and 24 engage with the respective threaded holes 14 and 16 of the box 10, the screws hold the device 100 in a fixed position relative to the box 10. Further turning of the screws 23 and 24 advances the receptacle 20 inwardly horizontally relative to the box 10 as indicated by arrow 97, while maintaining the device 100 in a fixed position relative to the box 10.

This aspect is used advantageously to secure the receptacle 20 in its final position in box 10, which is depicted in FIGS. 7A-7C. It can be seen that the screw 23 has been advanced to the point where the head 33 of screw 23 has seated against the ear 29 of the planar plate 22 of the receptacle 20, and the screw 24 has been advanced to the point where the head 35 of screw 24 has seated against the ear 30 of the planar plate 22 of the receptacle 20. Additionally, the planar plate 22 is forced against the frame 105 (FIG. 2A) of the device 100 formed by frame members 110, 120, 130, and 140. At this point, the screws 23 and 24 are in tension by their engagement with the tabs 13 and 15 of the box 10, and can no longer be turned. The receptacle 20 is thus firmly joined to the box 10. The device 10 is firmly held against the surface 6 of the wall 4.

Referring also to FIGS. 2A-2D, and as noted previously, the front edge 111 of the first side member 110 and the front edge 121 of the second side member 120 are coplanar and define a wall plane that is offset inwardly from the front plane defined by the front edge 131 of the third side member 130 and the front edge 141 of the fourth side member. The amount of inward offset may be made equal to the thickness of the planar plate 22 of the receptacle 20. Thus, when the receptacle 20 is firmly joined to the box 10 as described above, it is positioned with its planar plate in substantially the same position as it would be if the box 10 were “properly” installed relative to the wall 7 as shown in FIG. 1B and described previously. Advantageously, when the planar plate 22 of the receptacle 20 in its final position substantially coplanar with the surface 6 of the wall panel 4, then when the cover plate 40 is joined to the receptacle 20 and covers the front opening of the box 10, a pleasing aesthetic appearance and a safe installation is achieved.

It is further noted that in the event that the electrical box 10 is skewed with respect to the plane 6 of the wall panel 4 (as shown in FIG. 4 of the aforementioned U.S. Pat. No. 9,859,696), the clearance provided between the threaded shanks 34 and 36 of the screws 23 and 24 with the respective holes 31 and 32 enable the screws 23 and 24 to engage with the mounting tabs 190 and 195 of the fixture fitting device 100. Thus, in spite of the box 10 being mounted skewed with respect to the wall panel 4, the receptacle 20 is mounted in the desired position as described above.

The device of the present disclosure may be modified to join other types of parts together; in particular, other forms of electrical receptacle and boxes.

In one case, in which a boxed is mounted skewed in a wall, but with only one end of the box recessed beneath the plane of the wall surface, the device may only include the upper portion of the device 100 of FIGS. 2A-2E. Such a device may be comprised of a first side member 110, first and second ears 150 and 170, and a mounting tab 190.

In another case, the box may be a “gang” box,” configured to receive two or more electrical fixtures, such as receptacles, electrical switches, dimmers, etc. In such a case, the device may be configured with side members and ears joined together as described herein, and forming a multi-sided frame having a shape corresponding to the gang box.

In another case, the box may be a round (having circular cross section) or an “octagon” box,” configured to receive an electrical fixture, such as a receptacle, electrical switch, dimmer, etc. In such a case, the device may be configured with eight side members joined together as described herein but at 135 degree angles, and forming a multi-sided frame having a shape corresponding to the octagon box. The device may be further comprised of pairs of ears joined to two opposed side members of the device, as previously described herein.

It is therefore apparent that there has been provided, in accordance with the present disclosure, a device for optimizing installation of electrical fixtures in electrical boxes, and methods of using the device.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled.

I claim:

1. A device for joining a first part to a second part, the device comprising:
a) a multi-sided frame comprising:
a first side member including a front edge and having a first end and a second end;
a second side member opposite the first side member and including a front edge and having a first end and a second end, wherein the front edge of the first side member and the front edge of the second side member are coplanar and define a wall plane;
a third side member including a front edge and having a first end joined to the first end of the first side member and a second end joined to the first end of the second side member; and
a fourth side member opposite the third side member and including a front edge and having a first end joined to the second end of the first side member and a second end joined to the second end of the second side member, wherein the front edge of the third side member and the front edge of the fourth side member are coplanar and define a front plane;
b) a first ear extending laterally from proximate to the first end of the third side member and including a front surface and a rear surface;
c) a second ear extending laterally from proximate to the second end of the third side member and including a front surface and a rear surface;
d) a third ear extending laterally from proximate to the first end of the fourth side member and including a front surface and a rear surface;
e) a fourth ear extending laterally from proximate to the second end of the fourth side member and including a front surface and a rear surface;
f) a first mounting tab extending laterally from the first side member and including a rearward surface, a forward surface, and a threaded hole extending through the first mounting tab from the forward surface of the first mounting tab to the rearward surface of the first mounting tab; and
g) a second mounting tab extending laterally from the second side member and including a rearward surface, a forward surface, and a threaded hole extending through the second mounting tab from the forward surface of the second mounting tab to the rearward surface of the second mounting tab.

2. The device of claim 1, wherein the front surface of the first ear, the front surface of the second ear, the front surface of the third ear, and the front surface of the fourth ear are coplanar with the front plane.

3. The device of claim 1, wherein the rear surface of the first ear, the rear surface of the second ear, the rear surface of the third ear, and the rear surface of the fourth ear are coplanar and define a rear plane.

4. The device of claim 1, wherein the rear surface of the first ear, the rear surface of the second ear, the rear surface of the third ear, and the rear surface of the fourth ear are coplanar with the wall plane.

5. The device of claim 1, wherein the forward surface of the first mounting tab and the forward surface of the second mounting tab are coplanar with the wall plane.

6. The device of claim 1, wherein the first mounting tab and the second mounting tab are metal tabs.

7. The device of claim 1, wherein the first mounting tab is embedded in the first side member and the second mounting tab is embedded in the second side member.

8. The device of claim 1, wherein the wall plane is offset inwardly from the front plane.

9. An assembly of a first part comprised of first and second mounting screws and first and second ears, each of the ears having a fastening hole therethrough, a second part comprising a first and second tabs, each of the tabs having a threaded hole therethrough, and a device disposed between the first part and the second part, the device comprising:
a) a multi-sided frame comprising:
a first side member including a front edge and having a first end and a second end;
a second side member opposite the first side member and including a front edge and having a first end and a second end;
a third side member including a front edge and having a first end joined to the first end of the first side member and a second end joined to the first end of the second side member; and
a fourth side member opposite the third side member and including a front edge and having a first end joined to the second end of the first side member and a second end joined to the second end of the second side member;
b) a first mounting tab extending laterally from the first side member and including a rearward surface, a forward surface, and a threaded hole extending through the first mounting tab from the forward surface of the first mounting tab to the rearward surface of the first mounting tab; and
c) a second mounting tab extending laterally from the second side member and including a rearward surface, a forward surface, and a threaded hole extending through the second mounting tab from the forward surface of the second mounting tab to the rearward surface of the second mounting tab;
wherein the first mounting screw passes through the first fastening hole of the first part, though the threaded hole of the first mounting tab, and through the threaded hole of the first tab of the second part, and the second mounting screw passes through the second fastening hole of the first part, though the threaded hole of the second mounting tab, and through the threaded hole of the second tab of the second part.

10. The assembly of claim 9, wherein the device holds the first part at a fixed distance from the second part.

11. The assembly of claim 9, wherein the first and second mounting screws hold the device at a fixed distance from the second part.

12. The assembly of claim 9, wherein a surface of the first part is held contiguous with an edge of the device.

13. An electrical fixture assembly joinable to a box comprising a side wall terminating at an outer edge defining a planar opening, a first tab extending outwardly from a first side region of the side wall along the plane of the planar opening and including a first threaded hole therethrough, and a second tab extending outwardly from an opposed second side region of the side wall along the plane of the planar opening and including a second threaded hole therethrough; the electrical fixture assembly comprising:
a) an electrical fixture comprising:
a planar plate having a thickness and comprising a first end region including a first ear with a first hole therethrough, and an opposed second end region including a second ear with a second hole therethrough;
a first screw comprising a first head and a first elongated threaded shank, the first head of the first screw disposed against the first ear of the planar plate of the electrical fixture, and the first threaded shank extending through the first hole of the first ear, and engageable with threads in the first threaded hole of the first tab of the box; and
a second screw comprising a second head and a second elongated threaded shank, the second head of the second screw disposed against the second ear of the planar plate of the electrical fixture, and the second threaded shank extending through the second hole of the second ear, and engageable with threads in the second threaded hole of the second tab of the box; and
b) a fixture joining device comprising:
a multi-sided frame comprising a first side member including a front edge and having a first end and a second end; a second side member opposite the first side member and including a front edge and having a first end and a second end; a third side member including a front edge and having a first end joined to the first end of the first side member and a second end joined to the first end of the second side member; and a fourth side member opposite the third side member and including a front edge and having a first end joined to the second end of the first side member and a second end joined to the second end of the second side member;
a first mounting tab extending laterally from the first side member and including a rearward surface, a forward surface, and a threaded hole extending through the first mounting tab from the forward surface of the first mounting tab to the rearward surface of the first mounting tab; and
a second mounting tab extending laterally from the second side member and including a rearward surface, a forward surface, and a threaded hole extending through the second mounting tab from the forward surface of the second mounting tab to the rearward surface of the second mounting tab;
wherein when the assembly is joined to the box, the first screw passes through the first hole of the electrical fixture, though the threaded hole of the first mounting tab of the fixture joining device, and through the threaded hole of the first tab of the box, and the second mounting screw passes through the second hole of the electrical fixture, though the threaded hole of the second mounting tab, and through the threaded hole of the second tab of the box.

14. The electrical fixture assembly of claim 13, wherein the front edge of the first side member and the front edge of the second side member are coplanar and define a wall plane, and the front edge of the third side member and the front edge of the fourth side member are coplanar and define a front plane, and wherein the wall plane is offset inwardly from the front plane.

15. The electrical fixture assembly of claim 14, wherein the amount of offset of the front plane from the wall plane is equal to the thickness of the planar plate of the electrical fixture.

16. The electrical fixture assembly of claim 13, wherein when the assembly is joined to the box, the device holds the receptacle a fixed distance from the box.

17. The electrical fixture assembly of claim 13, wherein when the assembly is joined to the box, the first and second mounting screws hold the device at a fixed distance from the box.
